(19) United States
(12) Patent Application Publication
(10) Pub. No.: US 2025/0178971 A1
(43) Pub. Date: Jun. 5, 2025

(54) METHOD FOR PRODUCING CERAMIC SINTERED BODY AND COMPOSITION FOR MOLDING

(71) Applicant: Moulage LLC., Tokyo (JP)

(72) Inventor: Yoshimitsu KANKAWA, Taitou City (JP)

(73) Assignee: Moulage LLC., Tokyo (JP)

(21) Appl. No.: 18/909,059

(22) Filed: Oct. 8, 2024

(30) Foreign Application Priority Data
Nov. 30, 2023 (JP) 2023-202740

(51) Int. Cl. C04B 35/634; B28B 11/24; C04B 35/486; C04B 35/626; C04B 35/638; C04B 35/64

(52) U.S. Cl. CPC C04B 35/63408; B28B 11/243; C04B 35/486; C04B 35/6264; C04B 35/6342; C04B 35/63424; C04B 35/63488; C04B 35/638; C04B 35/64; C04B 2235/3246; C04B 2235/6021; C04B 2235/6022

(57) ABSTRACT

A composition for molding and a method for producing a ceramic sintered body which enable production of a sound debound body without bubbles, swelling, or cracking therein. The method uses a composition for molding containing 30 to 70% by volume of a ceramic powder and 30 to 75% by volume of an organic binder. The method includes the steps of: preparing a green body from the composition by using an injection molding machine or an extrusion molding machine; solvent-debinding the organic compound (C) in an amount equivalent to 30% by volume or more of the organic binder in the composition for molding, at a temperature of 40° C. or more and 80° C. or less with a solvent; heating the green body after the solvent-debinding to debinder the remaining organic binder; and sintering the ceramic green body.

### BACKGROUND

### 1. Technical Field

The present invention relates to a composition for extrusion molding and a composition for injection molding. The composition is used for a method of producing a molded body from a sinterable ceramic powder having an average particle size of 1 μm or less through injection molding or extrusion molding and of producing a sintered body product from the molded body. The present invention further relates to a debinding method.

### 2. Description of the Background

For injection molding or extrusion molding of ceramics, an organic binder is added to form an intended shape. The organic binder is used to make a shape in molding, and the added organic binder is to be removed by heating. A molding process of conventional injection molding or extrusion molding is shown in FIG. 1. In recent years, there is a strong demand for a ceramic product having the highest possible sintered density to improve the ceramic strength, heat resistance, thermal conductivity, or the like. To increase the sintered density, the finest possible powder having an average particle size of 1 μm or less is used. In such conditions, some organic binders may leave the carbon residue unless the binder is removed in an inert gas. When a powder having a particle size of 1 μm or less is used, the thermal-debinding time exceeds 24 hours. A green body having a wall thickness of more than 10 mm often suffers cracking or swelling during thermal-debinding even when the thermal-debinding is performed for 100 hours or more.

A solvent-debinding method (a solvent-extraction-debinding method) has been known for solving such problems as above, and Patent Literature 1 and Patent Literature 2 disclose debinding methods using water.

In the method using water as the extracting solvent, a water-soluble binder is used. When such a molding material or a green body is stored or regenerated, however, the flowability and the strength of the green body may deteriorate due to a high moisture absorption rate. A molding material containing water may develop fungi or the like, and this makes it difficult to regenerate the material. Water, which is used as an extraction solvent, has a boiling point of 100° C., whereas common nonaqueous organic solvents, such as ketone organic solvents, aromatic organic solvents, and chlorinated organic solvents, have a boiling point of 100° C. or less, and many nonaqueous organic solvents have a lower vapor pressure than that of water. Hence, the drying time in solvent-debinding with water is longer than that in solvent-debinding with an organic solvent.

Patent Literatures 3 and 4 and Non-Patent Literatures 1 and 2 each disclose a method of extraction-debinding an injection-green body that has been prepared by adding an organic binder to a metal powder, with an organic solvent. However, if the method is applied to a green body prepared from a ceramic powder, and the green body is subjected to solvent-debinding with an organic solvent, the green body suffers swelling in the solvent-debinding step, and a sound debound body is difficult to prepare after the solvent-debinding. The powder used in the metal powder injection molding method has an average particle size of about 5 to 10 μm, which is 10 to 100 times larger than that in the ceramic powder molding in which the average particle size is about 0.1 to 1 μm. Hence, the solvent-debinding of a metal powder green body can be completed even when a resin component in the used binder is not dissolved in an organic solvent but swells. In contrast, in injection molding or extrusion molding of a ceramic powder having a smaller particle size than the metal powder, the powder particle size is small, and accordingly, an organic solvent is difficult to easily escape from the green body. This causes swelling or cracking in the solvent-debinding step.

Patent Literature 5 discloses a method of performing solvent-debinding in which a ceramic powder is used, a polyethylene, a polypropylene, or a polyacetal is used as an organic binder, and a ketone organic solvent, a halogenated organic solvent, a hydrocarbon organic solvent, or an aromatic organic solvent is used as an extraction solvent. In Patent Literature 5, when a powder having a particle size of 0.1 μm or less is used, and the wall thickness of the green body is 3 mm or more, cracking is likely to be caused during solvent-debinding. A halogenated solvent was used in Examples, but use of not only chlorinated organic solvents but also brominated organic solvents is controlled from the viewpoint of environmental issues. This raises concerns about the restriction on the use of solvents. Preparing a green body having a complicated shape involves cracking problems that easily occur.

In recent years, many technical literatures have ascertained that using a fine powder having an average particle size of 0.1 μm or less enables low-temperature sintering (Non-Patent Literature 3). When a powder having an average particle size of 0.1 μm or less is used, however, it is difficult to prevent occurring cracking in the above conventional solvent-debinding method, and a sound sintered body is extremely difficult to produce.

### CITATION LIST

### Patent Literature

Patent Literature 1: JP 4330086 B
Patent Literature 2: JP 10-110201 A
Patent Literature 3: JP 02-194105 A
Patent Literature 4: JP 2009-527651 A
Patent Literature 5: JP 2021-138983 A

### Non-Patent Literature

Non-Patent Literature 1: “The Journal of the Japan Society of Powder and Powder Metallurgy,” Vol. 38, No. 6, p. 80
Non-Patent Literature 2: “The Journal of the Japan Society of Powder and Powder Metallurgy,” Vol. 49, No. 6, p. 518
Non-Patent Literature 3: “Materia Japan,” Vol. 33, No. 2, p. 155

### BRIEF SUMMARY

The present invention is intended to provide a method for producing a ceramic sintered body. In the method, a green body having a complicated shape can be prepared by injection molding or extrusion molding of a ceramic powder, an solvent-debinding step can be performed with an organic solvent such as acetone or an alcohol in a short time, and the ceramic sintered body can be prevented from suffering swelling or bubbling in the debinding step or a sintering step of the ceramic green body. The present invention is also intended to provide a composition for molding used for the production method.

An aspect of the present invention is a method for producing a ceramic sintered body from a composition for molding. The composition contains 30 to 70% by volume of a sinterable ceramic powder having an average particle size of 1.0 μm or less and 30 to 70% by volume of an organic binder.

The organic binder comprises a thermoplastic resin (A) not melting or swelling in an organic solvent, a thermoplastic resin (B) having a polar group, and an organic compound (C) to be dissolved in an organic solvent and having a melting point of 70° C. or less.

The thermoplastic resin (A) is contained at a proportion of 15 to 50% by volume in the whole organic binder, the thermoplastic resin (B) is contained at a proportion of 5 to 40% by volume in the whole organic binder, and the organic compound (C) is contained at a proportion of 30 to 75% by volume in the whole organic binder.

The method for producing a ceramic sintered body comprises the steps of: preparing a green body from the composition for molding by using an injection molding machine or an extrusion molding machine; solvent-debinding the organic compound (C) in an amount equivalent to 30% by volume or more of the whole organic binder in the composition for molding, at a temperature of 40° C. or more and 80° C. or less with a solvent capable of eluting the organic compound (C) in the prepared green body; heating the green body after the solvebt-debinding to debinder the organic binder remaining in the green body to prepare a ceramic green body; and sintering the ceramic green body to produce a ceramic sintered body.

A second aspect of the present invention is a composition for molding. The composition comprises 30 to 70% by volume of a sinterable ceramic powder having an average particle size of 1.0 μm or less and 30 to 70% by volume of an organic binder.

The organic binder contains a thermoplastic resin (A) not melting or swelling in an organic solvent, a thermoplastic resin (B) having a polar group, and an organic compound (C) to be dissolved in an organic solvent and having a melting point of 40° C. to 60° C.

The thermoplastic resin (A) is contained at a proportion of 15 to 50% by volume in the whole organic binder, the thermoplastic resin (B) is contained at a proportion of 5 to 40% by volume in the whole organic binder, and the organic compound (C) is contained at a proportion of 30 to 75% by volume in the whole organic binder.

By using the composition for molding and the debinding method pertaining to the present invention, a green body having a complicated shape and prepared by injection molding or extrusion molding of a ceramic powder having a small particle size of 1 μm or less is subjected to an solvent-debinding step with a solvent such as acetone or an alcohol and a thermal-debinding step in a short time, and the resulting debound body has no defects such as swelling or cracking. As a result, a sound sintered body can be produced for a short time.

### BRIEF DESCRIPTION OF DRAWINGS

FIG. 1 is a scheme showing a process of a ceramic sintered body in a prior art.

FIG. 2 is a scheme showing a process of a ceramic sintered body in the present invention.

FIG. 3 is a view showing the shape of an injection-molded green body prepared in Examples.

FIG. 4 is a view showing the shape of an extrusion-molded green body prepared in Examples.

FIG. 5 is a schematic view showing an example of an apparatus for the solvent-debinding step of the present invention.

FIG. 6 is a schematic view showing an example of an apparatus for the thermal-debinding step of the present invention.

FIG. 7 is an electron micrograph of the ceramic sintered body produced in Example 4.

FIG. 8 is a photograph of the green body after solvent-debinding produced in Comparative Example 1.

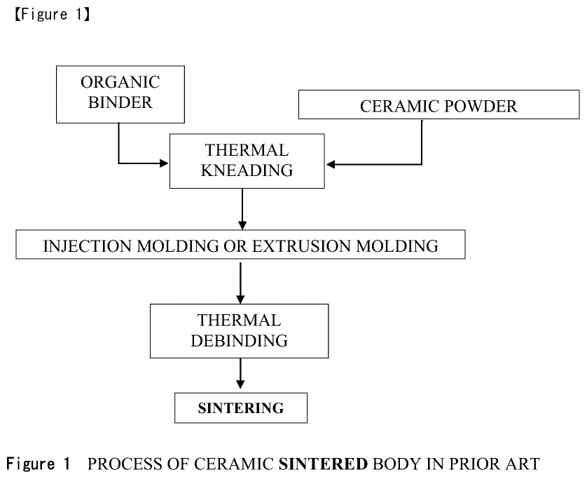

### DETAILED DESCRIPTION

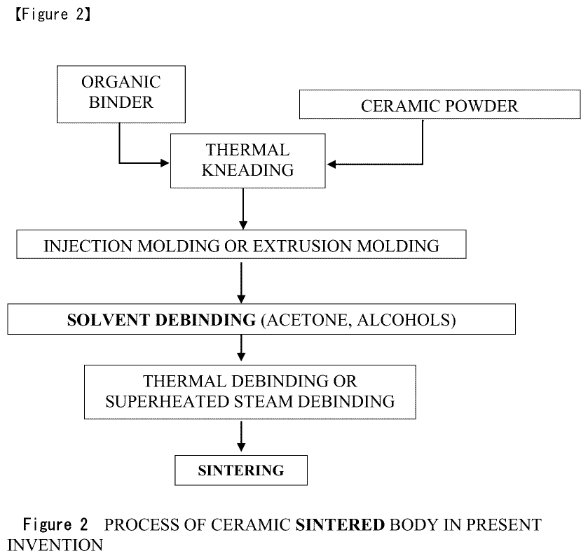

A first embodiment relates to a method for producing a ceramic sintered body, for example, through the scheme shown in FIG. 2. Specifically, a mixture of a ceramic powder and an organic binder is used as the material (a composition for molding) and is molded by a molding method such as injection molding or extrusion molding by using, for example, an injection molding machine or an extrusion molding machine to give a green body, and the green body is subjected to debinding and sintering to yield a ceramic sintered body as an intended product. In the method, a composition for molding containing a ceramic powder and an organic binder that contains a resin component not swelling in an organic solvent, a polar thermoplastic resin, and an organic compound to be dissolved in an organic solvent may be used. The composition for molding may be subjected to a molding method such as injection molding or extrusion molding, for example, at a molding temperature ranging from 140° C. to 200° C. to give a green body. The green body is next subjected to solvent-debinding with an organic solvent including acetone and alcohols and then is subjected to thermal-debinding. For the solvent-debinding of the green body, for example, the solvent-debinding apparatus shown in FIG. 5 may be used to extraction-debinder the organic compound (C) with an organic solvent including acetone and an alcohol solvent at a temperature of 50° C. to 80° C. for 1 to 12 hours. In FIG. 5, 1 is a green body; 2 is a solvent; and 3 is a solvent outlet. FIG. 5a shows a green body during an solvent-debinding; and FIG. 5b shows a green body after completion of solvent-debinding. In the solvent-debinding step, the green body is immersed in an extraction solvent to extract the organic compound (C) as shown in FIG. 5. At least 30% by volume of the whole organic binder may be removed in the solvent-debinding step to give a ceramic green body after solvent-debinding. The organic solvent used in the step may be any solvent capable of eluting the organic compound (C), but preferably includes acetone or an alcohol solvent such as methanol, ethanol, and isopropyl alcohol. A mixed organic solvent of acetone and an alcohol solvent may be used as the extraction solvent.

As compared to the conventional method, such a debinding method leads to production of a ceramic green body having a complicated shape, reduces the time for debinding, and enables production of a ceramic green body without cracking or swelling.

The green body after solvent-debinding prepared as above can yield a ceramic green body with no defects through the subsequent debinding step by thermal-debinding even at a temperature rise rate as high as 50° C./hr. After completion of the solvent-debinding step, thermal-debinding is performed in air or nitrogen. In the thermal-debinding, the temperature is increased over 2 to 20 hours such that the maximum temperature reaches 500° C. to 800° C., and the maximum temperature is maintained for 0.5 to 2 hours. In the thermal-debinding step, if the temperature rise time is less than 2 hours, the debound green body is likely to suffer cracking or swelling. Heating may be performed by using an electric heater, an oven, superheated steam, or other means. The prepared debound green body may be sintered in an atmosphere at a temperature suitable for the used ceramic powder (for example, at a temperature ranging from 900° C. to 2,300° C.), yielding a ceramic sintered body.

A second embodiment of the present invention is a composition for molding. The composition for molding of the second embodiment is suitably used for the production method of the first embodiment. The composition for molding of the second embodiment comprises 30 to 70% by volume of a sinterable ceramic powder having an average particle size of 1.0 μm or less and 30 to 70% by volume of an organic binder. In the composition, the organic binder is characterized by comprising a thermoplastic resin (A) not melting or swelling in an organic solvent, a thermoplastic resin (B) having a polar group, and an organic compound (C) to be dissolved in an organic solvent and having a melting point of 40° C. to 60° C.

In particular, as for the amount of the organic binder, the thermoplastic resin (A) is contained in an amount of 15 to 50% by volume relative to the volume of the organic binder, the thermoplastic resin (B) is contained in an amount of 5 to 40% by volume relative to the volume of the organic binder, and the organic compound (C) is contained in an amount of 30 to 75% by volume relative to the volume of the organic binder. The organic binder and the sinterable ceramic powder are preferably mixed at a volume ratio of 30:70 to 70:30.

Examples of the ceramic powder used in the composition for molding of the second embodiment include powders of oxide ceramics such as alumina, zirconia, magnesia, and titania, powders of nitride ceramics such as aluminum nitride and silicon nitride, and powders of carbide ceramics such as silicon carbide and boron carbide. The ceramic powder used in the production method of the first embodiment preferably has an average particle size of 0.01 μm or more and 1 μm or less. If a ceramic powder having a particle size of less than 0.01 μm is used, a large amount of the organic binder is needed for molding, and thus the ceramic green body is likely to suffer defects such as deforming, cracking, and swelling during solvent-debinding or thermal-debinding. If a ceramic powder having an average particle size of more than 1 μm is used, sintering insufficiently proceeds in the sintering step of a ceramic green body, and a ceramic sintered body having a high density and a high strength is difficult to produce. In the present description, the average particle size means the average diameter at a cumulative weight of 50% determined with a particle size distribution analyzer using the laser diffraction-scattering method. As the particle size distribution analyzer, SALD-2000 manufactured by Shimadzu Corporation may be used.

The thermoplastic resin (A) not melting or swelling in an organic solvent and used in the composition for molding of the second embodiment is a nonpolar thermoplastic resin, and is, for example, one thermoplastic resin or a mixture of a plurality of thermoplastic resins selected from the group consisting of high-density polyethylenes, polypropylene homopolymers, polypropylene block copolymers, and polyacetals. The thermoplastic resin (A) not melting or swelling in an organic solvent is contained in the organic binder in an amount of 15 to 50% by volume, preferably 20 to 45% by volume, and more preferably 25 to 35% by volume. If the organic binder contains the thermoplastic resin (A) at a content of less than 15% by volume, the green body molded from the composition for molding may be fragile. In addition, a ceramic green body after debinding of the green body may suffer swelling or cracking. If the organic binder contains the thermoplastic resin (A) at a content of more than 50% by volume, a high viscosity during molding makes it difficult to mold a green body having a complicated shape.

The thermoplastic resin (B) having a polar group and used in the composition for molding of the second embodiment is, for example, one thermoplastic resin or a mixture of a plurality of thermoplastic resins selected from the group consisting of ethylene-vinyl acetate resins, ethylene-glycidyl methacrylate copolymers, low-density polyethylenes, and polypropylene random copolymers. The thermoplastic resin (B) having a polar group is contained in the organic binder in an amount of 5 to 40% by volume, preferably 8 to 35% by volume, and more preferably 10 to 30% by volume. If the organic binder contains the thermoplastic resin (B) at a content of less than 5% by volume, the green body molded from the composition for molding may be fragile. If the organic binder contains the thermoplastic resin (B) at a content of more than 40% by volume, the green body molded from the composition for molding may suffer swelling or cracking.

The organic compound (C) having a melting point of 70° C. or less and used in the composition for molding of the second embodiment is, for example, one organic compound or a mixture of a plurality of organic compounds selected from the group consisting of paraffin waxes having a melting point of 40° C. to 70° C. and microcrystalline waxes. If the organic binder contains the organic compound (C) at a content of less than 30% by volume, the composition for molding has poor flowability during molding, and the green body is likely to suffer breaking and cracking. In addition, during solvent-debinding of the green body, the organic compound (C) may not be smoothly eluted. If the organic binder contains the organic compound (C) at a content of more than 75% by volume, the green body is likely to suffer burrs during molding of the composition for molding, and the green body may have insufficient strength. The organic binder suitably contains the organic compound (C) at a content of 30 to 75% by volume, preferably 40 to 70% by volume, and more preferably 50 to 65% by volume. If an organic compound (C) having a melting point of less than 40° C. is used, the organic compound (C) is likely to be separated from the green body, and the moldability deteriorates. If an organic compound (C) having a melting point of more than 59° C. is used, the organic compound (C) is extracted at an extremely low rate in the solvent-debinding step, and the ceramic green body may suffer swelling or cracking in the subsequent thermal-debinding step. In the production method of the first embodiment, a fatty acid ester, a polyethylene wax, a polypropylene wax, or an ester wax such as carnauba wax and montan wax may be added as an additive to the composition for molding to improve the moldability of the composition for molding. An additive such as an antioxidant may be used to maintain the stability of the composition for molding against heat.

The ceramic powder and the organic binder may be kneaded, for example, at a temperature ranging from 120 to 190° C. The composition for molding prepared by thermal-kneading is subjected to any known molding method such as injection molding or extrusion molding to give a green body. The prepared green body is subjected to solvent-debinding with an organic solvent including acetone or an alcohol at a temperature of 40° C. or more and 80° C. or less to extract the organic compound (C) in an amount equivalent to 30% by volume or more of the organic binder in the composition for molding, giving a ceramic green body after solvent-debinding. In the step, the temperature for solvent-debinding is preferably 40° C. to 80° C. If the temperature for solvent-debinding is 40° C. or less, the organic compound (C) is extracted at an extremely low rate, whereas if the temperature for solvent-debinding is more than 80° C., the resulting green body is likely to suffer swelling or cracking. From the ceramic green body after solvent-debinding, the organic solvent used for extraction is evaporated. The green body after solvent-debinding is next subjected to thermal-debinding in air or nitrogen. In the step, the temperature is increased over 2 to 20 hours such that the maximum temperature reaches 500° C. to 800° C., and the maximum temperature is maintained for 0.5 to 2 hours. In the thermal-debinding step, if the temperature rise time is less than 2 hours, the debound green body is likely to suffer cracking or swelling. Heating may be performed by using an electric heater, an oven, superheated steam, or other means. The prepared debound green body may be sintered in an atmosphere at a temperature suitable for the used ceramic powder (for example, at a temperature ranging from 900° C. to 2,300° C.), yielding a ceramic sintered body.

To prepare the composition for molding of the second embodiment, a sinterable ceramic powder may be kneaded with an organic binder containing a thermoplastic resin (A) not melting or swelling in an organic solvent, a polar thermoplastic resin (B), and an organic compound (C) having a melting point of 70° C. or less by using a batch-type or continuous-type kneader preferably at a temperature ranging from 140° C. to 180° C. for about 1 to 3 hours. The kneaded mixture may be pulverized into grains measuring a few millimeters in size to give the composition for molding of the second embodiment.

In the second embodiment, if the volume of the organic binder (the total volume of the thermoplastic resin (A), the thermoplastic resin (B), and the organic compound (C)) is less than 30% by volume relative to the total volume of the composition for molding (the total volume of the ceramic powder and the organic binder), the composition for molding has a high viscosity, and the green body is difficult to mold as well as the resulting green body is likely to fragile. If the volume of the organic binder (the total volume of the thermoplastic resin (A), the thermoplastic resin (B), and the organic compound (C)) is more than 70% by volume relative to the total volume of the composition for molding (the total volume of the ceramic powder and the organic binder), the ceramic green body is likely to suffer defects such as deforming, swelling, and cracking in the solvent solvent-debinding and thermal-debinding step.

Performing the method for producing a ceramic sintered body of the first embodiment with the composition for molding of the second embodiment enables production of a ceramic sintered body without any defect such as deforming, swelling, and cracking even after sintering.

Hereinafter, the present invention will be described in further detail with reference to Examples and Comparative Examples, but the present invention is not limited to them.

### Example 1

As the thermoplastic resin (A), a high-density polyethylene (HDPE, Asahi Kasei, Suntec J300) was used. An ethylene-vinyl acetate copolymer (EVA633, Tosoh, EVA633) as the thermoplastic resin (B), a paraffin wax (a melting point of 46° C.) as the organic compound (C), and stearic acid were used. These materials were place in a batch kneader and were homogeneously melted. Next, an yttria partially stabilized zirconia powder (Tosoh, TZ-3YE, a primary particle size of 0.01 μm) was added, and the whole was kneaded at 180° C. for 60 minutes. The kneaded product was taken out of the batch kneader and was pulverized to give a composition for molding.

### Composition for Molding

Yttria partially stabilized zirconia powder: 47% by volume

Organic binder: 53% by volume (The proportions in the organic binder) High-density polyethylene (thermoplastic resin (A)): 25% by volume

Ethylene-vinyl acetate (thermoplastic resin (B)): 20% by volume

Paraffin wax (organic compound (C)): 55% by volume

To improve the moldability, 5% by volume of stearic acid was added to the organic binder.

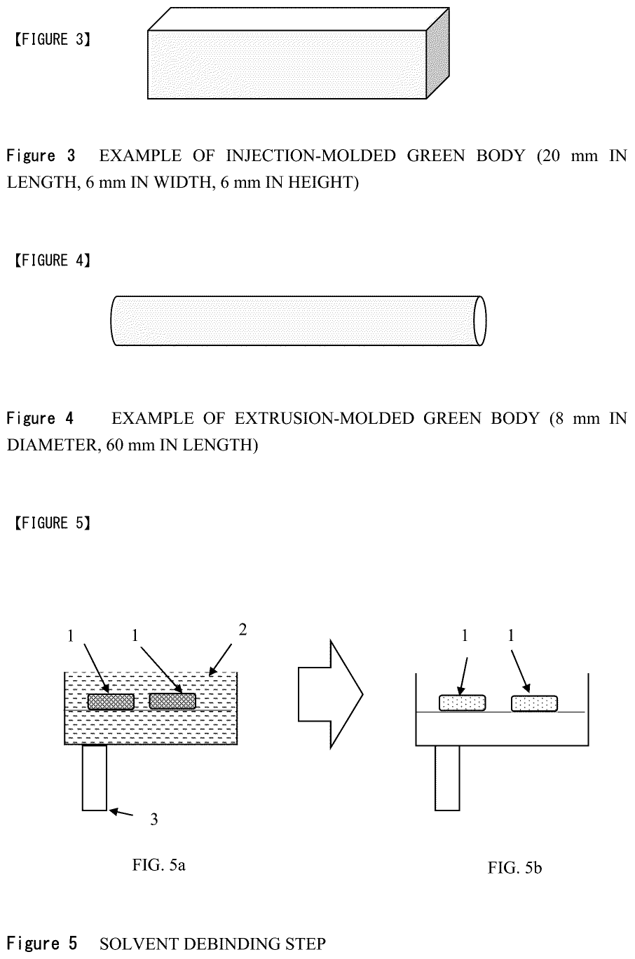

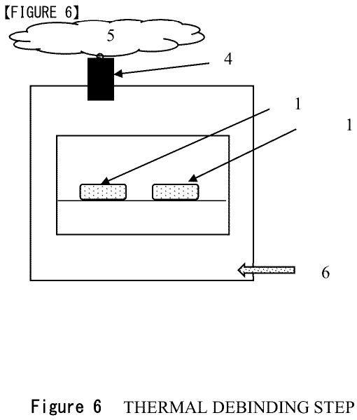

The prepared composition for molding was subjected to injection molding at a molding temperature of 180° C. to give a green body having the shape (6 mm in thickness, 6 mm in width, 20 mm in length) shown in FIG. 3. The prepared green body was immersed in acetone at a temperature of 52° C. for 8 hours in the solvent-debinding furnace shown in FIG. 5 for solvent-debinding, giving a ceramic green body after solvent-debinding. The ceramic green body after solvent-debinding was next placed in the thermal-debinding furnace shown in FIG. 6, and the temperature was increased from room temperature to 500° C. over 12 hours for debinding. In FIG. 6, 4 is a catalytic combustion apparatus; 5 is processed gas; and 6 is an inlet of air, nitrogen gas, or superheated steam. The furnace was then cooled, and a ceramic green body was prepared. The prepared ceramic green body was maintained in a sintering furnace in the atmosphere at 1,350° C. for 2 hours. The furnace was then cooled, and a ceramic sintered body was produced. The produced ceramic sintered body had no defects such as cracking or swelling and was sound. The sintered density was 6.05 g/cm³ (relative density: 100%).

### Example 2

As the thermoplastic resin (A), a polypropylene homopolymer (PP, Prime Polymer, J107G) was used. An ethylene-glycidyl methacrylate (EGMA, Sumitomo Chemical, Bondfast 7B) as the thermoplastic resin (B), a paraffin wax (a melting point of 53° C.) as the organic compound (C), carnauba wax, and stearic acid were placed in a batch kneader and were homogeneously melted. An alumina powder (Taimei Chemicals, TM-DAR, an average particle size of 0.12 μm) was then added, and the whole was kneaded at 180° C. for 60 minutes in the batch kneader. The kneaded product was taken out and was pulverized to give a composition for molding.

### Composition for Molding

Alumina powder: 50% by volume

Organic binder: 50% by volume

(The proportions in the organic binder)

Polypropylene homopolymer (thermoplastic resin (A)): 25% by volume

Ethylene-glycidyl methacrylate (thermoplastic resin (B)): 25% by volume

Paraffin wax (organic compound (C)): 50% by volume

To improve the moldability, 5% by volume of carnauba wax and 5% by volume of stearic acid were added to the organic binder.

The prepared molding material was subjected to extrusion molding at a molding temperature of 180° C. to give a green body having the shape (a rod-like shape measuring 5 mm in diameter and 60 mm in length) shown in FIG. 4. The prepared green body was immersed in ethanol at a temperature of 65° C. for 8 hours in the solvent-debinding furnace shown in FIG. 5 for solvent-debinding, giving a ceramic green body after solvent-debinding. The ceramic green body after solvent-debinding was next placed in a superheated steam debinding furnace, and the temperature was increased from 200° C. to 500° C. over 2 hours. The furnace was then cooled, and a ceramic green body was prepared. The prepared ceramic green body was maintained in a sintering furnace in the atmosphere at 1,600° C. for 2 hours. The furnace was then cooled, and a ceramic sintered body was produced. The produced ceramic sintered body had no defects such as cracking or swelling and was sound. The sintered density was 3.98 g/cm³ (relative density: 99.5%).

### Example 3

A polyacetal (POM, Polyplastics, M90-44) and a polypropylene homopolymer (PP-HM, Prime Polymer, J107G) as the thermoplastic resin (A), an ethylene-vinyl acetate copolymer and a low-density polyethylene as the organic compound (B), and a paraffin wax (a melting point of 53° C.) as the organic compound (C) were placed in a batch kneader and were homogeneously melted. An alumina powder (Taimei Chemicals, TM-DAR, an average particle size of 0.12 μm) was then added, and the whole was kneaded at 180° C. for 60 minutes in the batch kneader. The kneaded product was taken out and was pulverized to give a composition for molding.

### Composition for Molding

Alumina powder: 50% by volume

Organic binder: 50% by volume

(The proportions in the organic binder)

Polyacetal (thermoplastic resin (A)): 10% by volume

Polypropylene homopolymer (thermoplastic resin (A)): 10% by volume

Ethylene-vinyl acetate copolymer (thermoplastic resin (B)): 15% by volume

Low-density polyethylene (thermoplastic resin (B)): 10% by volume

Paraffin wax (organic compound (C)): 55% by volume

To improve the moldability, 5% by volume of carnauba wax and 5% by volume of stearic acid were added to the organic binder.

The prepared molding material was subjected to injection molding at a molding temperature of 180° C. to give a green body having the shape (6 mm in thickness, 6 mm in width, 20 mm in length) shown in FIG. 3. The prepared green body was immersed in isopropyl alcohol at a temperature of 70° C. for 8 hours in the solvent-debinding furnace shown in FIG. 5 for solvent-debinding, giving a ceramic green body after solvent-debinding. The ceramic green body after solvent-debinding was next placed in a thermal-debinding furnace, and the temperature was increased from 200° C. to 500° C. over 5 hours. The furnace was then cooled, and a ceramic green body was prepared. The prepared ceramic green body was maintained in a sintering furnace in the atmosphere at 1,600° C. for 2 hours. The furnace was then cooled, and a ceramic sintered body was produced. The produced ceramic sintered body had no defects such as cracking or swelling and was sound. The sintered density was 3.95 g/cm³ (relative density: 99.5%).

### Example 4

A high-density polyethylene (HDPE, Asahi Kasei, Suntec J300) as the thermoplastic resin (A), an ethylene-vinyl acetate copolymer (EVA633, Tosoh, EVA633) as the thermoplastic resin (B), a paraffin wax (melting point 46° C.) as the organic compound (C), and stearic acid were placed in a batch kneader and were homogeneously melted. An aluminum nitride powder (Tokuyama, grade E, a particle size of 1.0 μm) with 2% by mole of yttrium oxide was then added, and the whole was kneaded at 180° C. for 60 minutes in the batch kneader. The kneaded product was taken out and was pulverized to give a composition for molding.

### Composition for Molding

Aluminum nitride powder (with 2% by mole of yttrium): 50% by volume

Organic binder: 50% by volume

(The proportions in the organic binder)

High-density polyethylene (thermoplastic resin (A)): 25% by volume

Ethylene-vinyl acetate (thermoplastic resin (B)): 20% by volume

Paraffin wax (organic compound (C)): 55% by volume

To improve the moldability, 5% by volume of stearic acid was added to the organic binder.

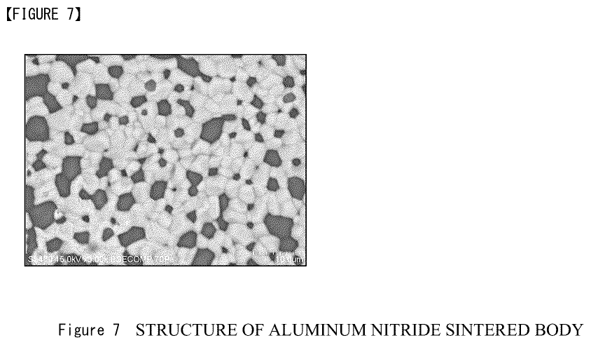

The prepared molding material was subjected to injection molding at a molding temperature of 180° C. to give a green body having the shape (6 mm in thickness, 6 mm in width, 20 mm in length) shown in FIG. 3. The prepared green body was immersed in a mixed liquid of acetone and isopropyl alcohol at a weight ratio of 1:1 at a temperature of 52° C. for 8 hours in the solvent-debinding furnace shown in FIG. 5 for solvent-debinding, giving a ceramic green body after solvent-debinding. The ceramic green body after solvent-debinding was next placed in a thermal-debinding furnace, and the temperature was increased from room temperature to 500° C. over 12 hours. The furnace was then cooled, and a ceramic green body was prepared. The prepared ceramic green body was maintained in a sintering furnace in the atmosphere at 1,850° C. for 2 hours. The furnace was then cooled, and a ceramic sintered body was produced (FIG. 7 is an electron micrograph of the ceramic sintered body in Example 4). The produced ceramic sintered body had no defects such as cracking or swelling and was sound. The sintered density was 3.32 g/cm³. The ceramic sintered body had a thermal conductivity of 180 W/mK and was revealed to have high thermal conductivity.

### Comparative Example 1

An ethylene-vinyl acetate copolymer resin (EVA, EVAFLEX EV250) as the thermoplastic resin (B), a paraffin wax (a melting point of 53° C.) as the organic compound (C), carnauba wax, and stearic acid were placed in a batch kneader and were homogeneously melted. An yttria partially stabilized zirconia powder (Tosoh, TZ-3YE, a primary particle size of 0.01 μm) was then added, and the whole was kneaded at 180° C. for 60 minutes in the batch kneader. The kneaded product was taken out and was pulverized to give a composition for molding.

### Composition for Molding

Yttria partially stabilized zirconia powder: 50% by volume

Organic binder: 50% by volume

(The proportions in the organic binder)

Ethylene-vinyl acetate copolymer resin (thermoplastic resin (B)): 40% by volume

Paraffin wax (organic compound (C)): 60% by volume

To improve the moldability, 5% by volume of carnauba wax and 5% by volume of stearic acid were added to the organic binder.

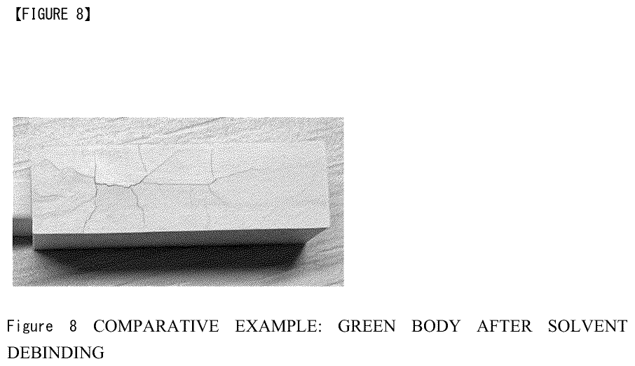

The prepared molding material was subjected to injection molding at a molding temperature of 180° C. to give a green body having the shape (6 mm in thickness, 6 mm in width, 20 mm in length) shown in FIG. 3. The prepared green body was immersed in acetone at a temperature of 60° C. for 8 hours in the solvent-debinding furnace shown in FIG. 5 for solvent-debinding, giving a ceramic green body after solvent-debinding. The prepared ceramic green body suffered cracking and swelling as shown in FIG. 8 and was failed to be subjected to the subsequent solvent-debinding, thermal-debinding, and sintering.

### Comparative Example 2

A low-density polyethylene (LDPE, Novatec, UJ580) as the thermoplastic resin (A) and a paraffin wax (a melting point of 53° C.) as the organic compound (C) were placed in a batch kneader and were homogeneously melted. An alumina powder (Taimei Chemicals, TM-DAR, an average particle size of 0.12 μm) was then added, and the whole was kneaded at 180° C. for 60 minutes in the batch kneader. The kneaded product was taken out and was pulverized to give a composition for molding.

### Composition for Molding

Alumina powder: 50% by volume

Organic binder: 50% by volume

(The proportions in the organic binder)

Low-density polyethylene (thermoplastic resin (A)): 40% by volume

Paraffin wax (organic compound (C)): 60% by volume

To improve the moldability, 5% by volume of carnauba wax and 5% by volume of stearic acid were added to the organic binder.

The prepared molding material was subjected to injection molding at a molding temperature of 180° C. to give a green body having the shape (6 mm in thickness, 6 mm in width, 20 mm in length) shown in FIG. 3. The prepared green body was immersed in normal-hexane at a temperature of 60° C. for 8 hours in the solvent-debinding furnace shown in FIG. 5 for solvent-debinding, giving a ceramic green body after solvent-debinding. The prepared ceramic green body suffered cracking and swelling and was failed to be subjected to the subsequent solvent-debinding, thermal-debinding, and sintering.

### Comparative Example 3

A polyacetal (POM, Polyplastics, M90-44) as the thermoplastic resin (A), an ethylene-vinyl acetate copolymer resin (EVA, EVAFLEX EV250) as the thermoplastic resin (B), and a paraffin wax (melting point 53° C.) as the organic compound (C) were placed in a batch kneader and were homogeneously melted. An alumina powder (Taimei Chemicals, TM-DAR, an average particle size of 0.12 μm) was then added, and the whole was kneaded at 180° C. for 60 minutes in the batch kneader. The kneaded product was taken out and was pulverized to give a composition for molding.

### Composition for Molding

Alumina powder: 50% by volume

Organic binder: 50% by volume

(The proportions in the organic binder)

Polyacetal (thermoplastic resin (A)): 20% by volume Ethylene-vinyl acetate copolymer resin (thermoplastic resin (B)): 20% by volume

Paraffin wax (organic compound (C)): 60% by volume

To improve the moldability, 5% by volume of carnauba wax and 5% by volume of stearic acid were added to the organic binder.

The prepared molding material was subjected to injection molding at a molding temperature of 180° C. to give a green body having the shape (6 mm in thickness, 6 mm in width, 20 mm in length) shown in FIG. 3. The prepared green body was immersed in 1,1,2,2-tetrafluoroethyl-2,2,2-trifluoroethyl ether at a temperature of 50° C. for 8 hours in the solvent-debinding furnace shown in FIG. 5 for solvent-debinding, giving a ceramic green body after solvent-debinding. The prepared ceramic green body suffered cracking and swelling and was failed to be subjected to the subsequent solvent-debinding, thermal-debinding, and sintering.

### Examples 5 to 12, Comparative Examples 4 to 7

Experiments were further conducted while various organic binder components were used. The formulations of the used organic binders are shown in Table 1, and the formulations in the injection molding and the results are shown in Table 2. The kneading, debinding, and sintering conditions were substantially the same as in Example 1. The dimensions of the green body was substantially the same as those of the green body shown in FIG. 3.

The items in Table 1 are as shown below.

Ceramic powder: (zirconia, Tosoh, TZ-3YE)

Organic binder components (% by volume)

### (Thermoplastic Resin (A))

High-density polyethylene (HDPE, Japan Polyethylene, HJ560)

Polypropylene homopolymer (PP, Prime Polymer, J107G)

Polyacetal (POM, Polyplastics, M90-44)

### (Thermoplastic Resin (B))

Ethylene-vinyl acetate copolymer (EVA, Tosoh, EVA633)

Ethylene-glycidyl methacrylate (EGMA, Sumitomo Chemical, Bondfast 7B)

### (Organic Compound (C))

Paraffin wax (a melting point of 48° C.): F-115

Paraffin wax (a melting point of 53° C.): F-125

### (Other Additives)

Carnauba wax: CWAX

Stearic acid: STA

Solvent-debinding solvent: isopropyl alcohol

Solvent-debinding temperature: 75° C.

TABLE 1
Organic binder formulation

| | Unit: % by volume | | | | | | | | Unit: % by volume | | | | |
|---|---|---|---|---|---|---|---|---|---|---|---|---|---|
| | | | | | | | | Resin A + | | | | | |
| | | | | | | | | Resin B | F-115 | F-125 | Sum of | CWA | STA |
| | HDPE | PP | POM | Sum of | EVA | EGMA | Sum of | Sum of | Organic | | organic | Other | |
| Formulation | Resin A | | | Resin A | Resin B | | Resin B | resins | compound (C) | | binders | additives | |
| A | 30 | | | 30 | 15 | 15 | 30 | 60 | 40 | | 100 | 5 | 5 |
| B | | 30 | | 30 | 10 | 10 | 20 | 50 | 25 | 25 | 100 | 5 | 5 |
| C | 20 | | 10 | 30 | 10 | 10 | 20 | 50 | 50 | | 100 | 5 | 5 |
| D | 5 | 10 | | 15 | 20 | | 20 | 35 | 40 | | 75 | 5 | 5 |
| E | 10 | 10 | 10 | 30 | 10 | 10 | 20 | 50 | 20 | 30 | 100 | 5 | 5 |
| F | 20 | 10 | | 30 | | 20 | 20 | 50 | | 50 | 100 | 5 | 5 |
| G | | 15 | 15 | 30 | 10 | 10 | 20 | 50 | | 50 | 100 | 5 | 5 |
| H | 5 | 20 | 5 | 30 | 20 | | 20 | 50 | | 50 | 100 | 5 | 5 |
| a | | | | 0 | 40 | | 40 | 60 | 40 | | 100 | 5 | 5 |
| b | | | | 0 | | 40 | 40 | 60 | 40 | | 100 | 5 | 5 |
| c | | | | 0 | 30 | 20 | 50 | 50 | 25 | 25 | 100 | 5 | 5 |
| d | | 10 | | 10 | | | 0 | 10 | 90 | | 100 | 5 | 5 |

TABLE 2
Molding, debinding, and sintering results

| | | | | | | Defects in | | | |
|---|---|---|---|---|---|---|---|---|---|
| | | | Composition for molding | | | extraction- | | | |
| | | | (% by volume) | | Green body | debound | Defects in | Defects in | Sintered |
| | Powder | Binder | Powder | Binder | defects | body | debound body | sintered body | density (%) |
| Example 5 | Zirconia | A | 45 | 55 | Not observed | Not observed | Not observed | Not observed | 99.8 |
| Example 6 | powder | B | 45 | 55 | Not observed | Not observed | Not observed | Not observed | 99.5 |
| Example 7 | | C | 45 | 55 | Not observed | Not observed | Not observed | Not observed | 99.7 |
| Example 8 | | D | 45 | 55 | Not observed | Not observed | Not observed | Not observed | 99.6 |
| Example 9 | | E | 45 | 55 | Not observed | Not observed | Not observed | Not observed | 99.4 |
| Example 10 | | F | 45 | 55 | Not observed | Not observed | Not observed | Not observed | 99.5 |
| Example 11 | | G | 45 | 55 | Not observed | Not observed | Nor observed | Not observed | 99.6 |
| Example 12 | | H | 45 | 55 | Not observed | Not observed | Not observed | Not observed | 99.5 |
| Comparative | | a | 45 | 55 | Not observed | Cracking, swelling | — | — | — |
| Example 4 | | | | | | | | | |
| Comparative | | b | 45 | 55 | Not observed | Cracking, swelling | — | — | — |
| Example 5 | | | | | | | | | |
| Comparative | | c | 45 | 55 | Not observed | Cracking, swelling | — | — | — |
| Example 6 | | | | | | | | | |
| Comparative | | d | 45 | 55 | Fragile | — | — | — | — |
| Example 7 | | | | | | | | | |

As shown in Table 2, in Examples 5 to 12, each organic binder was prepared according to a formulation within the scope of the invention (A to H in Table 1); 45% by volume of a partially stabilized zirconia powder (a primary particle size of 0.01 μm) and 55% by volume of the organic binder were mixed; the mixture was thermally kneaded at 180° C.; the prepared composition for molding was subjected to injection molding at a molding temperature of 180° C.; and consequently a green body having the shape (6 mm in thickness, 6 mm in width, 20 mm in length) shown in FIG. 3 was prepared. The prepared green body was immersed in isopropyl alcohol for 8 hours in a container at a temperature of 50° C. in the thermal-debinding furnace shown in FIG. 5 for solvent-debinding. The temperature was then increased from 200° C. to 500° C. over 5 hours. The furnace was then cooled, and a ceramic green body was prepared. The prepared ceramic green body was sound and was sintered in a sintering furnace in the argon atmosphere at 1,600° C. The produced ceramic sintered bodies each had no cracking, swelling, or other defects. Each ceramic sintered body had a relative sintered density of 99% or more where the sintered density (6.05 g/cm³) of the partially stabilized zirconia was 100%, and a sound sintered body was able to be produced. The test results are shown in Table 2.

In contrast, in Comparative Examples 4 to 7, organic binders were prepared according to component formulations out of the scope of the present invention (a to d in Table 1). Compositions for molding were prepared in the same conditions as in Examples 5 to 12, and molded bodies were prepared in the same conditions as in Examples 5 to 12. In Comparative Example 7, the prepared green body was very fragile, and a sound green body was failed to be prepared. In Comparative Examples 4 to 6, solvent-debinding was performed in the same conditions as in Examples 5 to 12, but the prepared ceramic molded bodies after solvent-debinding suffered swelling or cracking as shown in Table 2 and were not sound ceramic molded bodies.

When the molded bodies in Examples 1 to 3 were subjected to solvent-debinding such that the extraction rate was less than 30% by volume in the whole organic binder, and the molded bodied after solvent-debinding were next subjected to thermal-debinding at a temperature rise rate of 200° C./hr, the prepared ceramic molded bodies suffered cracking or swelling. This result ascertains that solvent-debinding is preferably performed such that the extraction rate is 30% by volume or more in the whole organic binder.

### INDUSTRIAL APPLICABILITY

Use of the composition for molding of the present invention enabled production of a sound ceramic green body and ceramic sintered body having a complicated shape but having no defects for a short time. The present invention promotes application of a part having a complicated shape to medical parts, automobile parts, and telecommunication equipment parts.

1. A method for producing a ceramic sintered body from a composition for molding, the composition for molding comprising 30 to 70% by volume of a sinterable ceramic powder having an average particle size of 1.0 μm or less and 30 to 70% by volume of an organic binder,
the organic binder comprising a thermoplastic resin (A) not melting or swelling in an organic solvent, a thermoplastic resin (B) having a polar group, and an organic compound (C) to be dissolved in an organic solvent and having a melting point of 70° C. or less,
the thermoplastic resin (A) being comprised at a proportion of 15 to 50% by volume in the whole organic binder,
the thermoplastic resin (B) being comprised at a proportion of 5 to 40% by volume in the whole organic binder,
the organic compound (C) being comprised at a proportion of 30 to 75% by volume in the whole organic binder,
the method comprising the steps of:
preparing a green body from the composition for molding by using an injection molding machine or an extrusion molding machine;
solvent-debinding the organic compound (C) in an amount equivalent to 30% by volume or more of the organic binder in the composition for molding, at a temperature of 40° C. or more and 80° C. or less with a solvent capable of eluting the organic compound (C) in the prepared green body,
heating a green body after the solvent-debinding to debinder the organic binder remaining in the green body to prepare a ceramic green body; and
sintering the ceramic green body to produce a ceramic sintered body.

2. The method for producing a ceramic sintered body according to claim 1, wherein the thermoplastic resin (A) comprises one thermoplastic resin or a mixture of thermoplastic resins selected from the group consisting of high-density polyethylenes, polypropylene homopolymers, polypropylene block copolymers, and polyacetals, the thermoplastic resin (B) comprises one thermoplastic resin or a mixture of thermoplastic resins selected from the group consisting of ethylene-vinyl acetate copolymers, ethylene-glycidyl methacrylate copolymers, low-density polyethylenes, and polypropylene random copolymers, and
the organic compound (C) comprises one organic compound or a mixture of organic compounds selected from the group consisting of paraffin wax and micro crystalline wax.

3. The method for producing a ceramic sintered body according to claim 1, wherein the solvent used in the solvent-debinding comprises one or mixture selected from the group consisting of acetone, methanol, ethanol, an isopropyl alcohol.

4. A composition for molding comprising 30 to 70% by volume of a sinterable ceramic powder having an average particle size of 1.0 μm or less and 30 to 70% by volume of an organic binder,
the organic binder containing a thermoplastic resin (A) not melting or swelling in an organic solvent, a thermoplastic resin (B) having a polar group, and an organic compound (C) to be dissolved in an organic solvent and having a melting point of 70° C. or less,
the thermoplastic resin (A) being contained at a proportion of 15 to 50% by volume in the whole organic binder,
the thermoplastic resin (B) being contained at a proportion of 5 to 40% by volume in the whole organic binder,
the organic compound (C) being contained at a proportion of 30 to 75% by volume in the whole organic binder.

5. The composition for molding according to claim 4, wherein the ceramic is an oxide ceramic selected from the group consisting of alumina, zirconia, magnesia, and titania, a nitride ceramic selected from the group consisting of aluminum nitride and silicon nitride, a carbide ceramic selected from the group consisting of silicon carbide and boron carbide, or a mixture thereof.

6. The composition for molding according to claim 4, wherein the thermoplastic resin (A) comprises one thermoplastic resin or a mixture of thermoplastic resins selected from the group consisting of high-density polyethylenes, polypropylene homopolymers, polypropylene block copolymers, and polyacetals,
the thermoplastic resin (B) comprises one thermoplastic resin or a mixture of thermoplastic resins selected from the group consisting of ethylene-vinyl acetate copolymers, ethylene-glycidyl methacrylate copolymers, low-density polyethylenes, and polypropylene random copolymers, and
the organic compound (C) comprises one organic compound or a mixture of organic compounds selected from the group consisting of paraffin wax and micro crystalline wax.

7. The composition for molding according to claim 5, wherein the thermoplastic resin (A) comprises one thermoplastic resin or a mixture of thermoplastic resins selected from the group consisting of high-density polyethylenes, polypropylene homopolymers, polypropylene block copolymers, and polyacetals,
the thermoplastic resin (B) comprises one thermoplastic resin or a mixture of thermoplastic resins selected from the group consisting of ethylene-vinyl acetate copolymers, ethylene-glycidyl methacrylate copolymers, low-density polyethylenes, and polypropylene random copolymers, and
the organic compound (C) comprises one organic compound or a mixture of organic compounds selected from the group consisting of paraffin wax and micro crystalline wax.
